(19) United States
(12) Patent Application Publication
(10) Pub. No.: US 2007/0271158 A1
(43) Pub. Date: Nov. 22, 2007

(54) System and method for automated generation, management and documentation of device assemblies

(75) Inventors: Harald Muller, Bobenheim-Roxheim (DE); Wolfgang Bremmer, Worms (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 11/797,751

(22) Filed: May 7, 2007

(30) Foreign Application Priority Data
May 8, 2006 (DE) 10 2006 021 541.9

(51) Int. Cl. G06Q 10/00

(52) U.S. Cl. 705/28

(57) ABSTRACT

A system and a method are disclosed for automated generation, management and documentation of device assemblies by means of a data processing system, which has at least one data source for the supply of mass data and an entry module for creating and managing objects. The entry module interacts with a graphic module, which generates schemas from a combination of the created objects, and transfers the schemas generated by the graphic module into a processing module for the generation of one-to-one corresponding instances by means of a multiple allocation of the schemas to the mass data.

### RELATED APPLICATIONS

This application claims priority under 35 U.S.C. §119 to German Application 10 2006 021 541.9 filed in Germany on May 08, 2006, the entire contents of which are hereby incorporated by reference in their entireties.

### TECHNICAL FIELD

A system and a method are disclosed for automated generation, management and documentation of device assemblies by means of a data processing system. The disclosure can find use in plant engineering, control and instrumentation, and process planning.

### BACKGROUND INFORMATION

Known methods for the management and documentation of device assemblies, for example for generating and managing two-dimensional graphics with a parts list, for the creation of a costing, for the management of central objects and the formation of specific mass data by instantiation, and for the management of documents, are currently implemented on different platforms and cannot be coupled to one another. An exchange of data is only possible over additional interfaces, and requires adjustment of the formats and data content.

The uniqueness of the data is also not necessarily guaranteed and must be ensured by manual checking and costly post-processing.

Operation of the interfaces is not automated: it must be triggered by the user.

A further disadvantage relates to the data transfers which often take place at different times, leading to the danger of inconsistencies from different processing states.

The time taken for operating the interfaces and checking the transferred data can be estimated at best, and is proportionally related to the quantity of mass data. Being carried out by a person, this manual comparison activity leads to errors, which furthermore cannot necessarily be reproduced.

### SUMMARY

a system and a method are disclosed for automated generation, management and documentation of device assemblies by means of a data processing system, whereby aforementioned known disadvantages are overcome.

An exemplary system for automated generation, management and documentation of device assemblies by means of a data processing system includes at least one data source for the supply of mass data and an entry module for creating and managing objects, the entry module interacting with a graphic module, which generates schemas from a combination of the created objects. The created objects describe, for example, component parts and/or freestanding devices with their attributes, data and documents, such as electrotechnical components and field devices of a technical plant. The mass data can be process and procedure data, which is supplied in the form of consumer lists and/or instrumentation lists, for example.

The schemas generated by the graphic module can be transferred into a processing module for the generation of one-to-one corresponding instances by means of a multiple allocation of the schemas to the mass data. The term instances is used to describe data of identical objects or symbols, which are stored only once, the objects then being instances of the device type which is stored once. The instances generated by the processing module can be represented and/or further processed as device assemblies with a complete documentation by means of an evaluation module.

The schemas generated using the graphic module are made up of several component parts and/or freestanding devices, the objects, which are managed in the data processing system with all their attributes, data and documents.

Exemplary device assemblies can be graphically represented and equipped with parts lists which are dependent on delivery limits. From the dataset thus generated, counts, statistics and summaries can be generated and/or presented by means of an output and/or display module.

It is further provided that—as well as the descriptive information—prices, discounts and costs also be allocated to the objects and schemas, so that cost statements, cost catalogues and purchase requisitions can advantageously be generated.

### BRIEF DESCRIPTION OF THE DRAWING

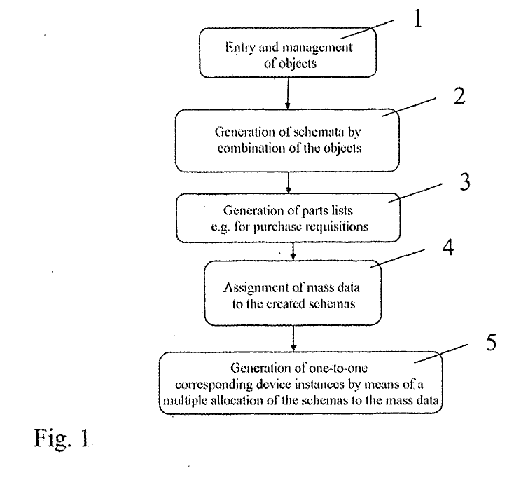

With the help of the exemplary embodiment of a method for automated generation, management and documentation of device assemblies by means of a data processing system shown in FIG. 1, the invention should be further explained and described, along with advantageous developments, improvements and further advantages of the disclosure.

### DETAILED DESCRIPTION

FIG. 1 shows an exemplary embodiment of the method for automated generation, management and documentation of device assemblies by means of a data processing system, with reference to the procedural steps 1 to 5.

In a first step 1, objects i.e. component parts and/or freestanding devices, which are e.g. purchasable products and services, are created and managed with an entry module. These component parts and/or freestanding devices are uniquely named by a so-called identifier, and are described by defined data fields.

As well as the general technical information, cost-related, shipping-specific and order data is also held. Documents as wished, such as data sheets or certificates, are assigned to the component parts and/or freestanding devices. The component parts and/or freestanding devices are further given freely configurable graphic symbols for representation in the schema and/or further graphic representation forms.

In a second step 2, schemas—supported by graphic procedures—are generated through a combination of the component parts and/or freestanding devices created by the entry module, by means of an arrangement or interconnection by a processing module.

In an exemplary embodiment of the method, in a further step 3 a parts list is generated in addition to the graphic representation of the schemas, the representation of the component parts and/or freestanding device symbols and the composition of the parts list both differing according to the specified delivery limits. On the basis of the parts lists generated in this way, automated generation of purchase requisitions is thus possible.

The general technical information stored in defined data fields of the schemas is presented in a suitable form such as data fields and/or data sheets.

Cost-related data and any documents as wished can also be assigned to the schemas.

In a subsequent step 4, the mass data records supplied from a data source are assigned by means of a processing module to the schemas created from the component parts and/or freestanding devices, each data record representing a real requirement.

By means of the assignment of the supplied mass data records to the schemas, in a last step 5 specific instances are formed. Counts, statistics and summaries can thereby advantageously be generated.

In a further exemplary embodiment, the objects and schemas are also allocated associated documents, which, taking into account the generated instances of the objects and schemas used, can be saved in a central database.

An exemplary method is based on a multi-stage integrated procedural sequence, in which mass data is supplied by at least one data source and objects are created and managed by the entry module.

From the objects created by the entry module, schemas are created by a graphic module through a combination of the objects. The schemas generated by the graphic module are then transferred into a processing module for the generation of one-to-one corresponding instances by means of a multiple allocation of the schemas to the mass data.

Advantageously, the creation and management of the objects and schemas, as well as the management of the mass data records e.g. for the creation of a costing, is executed from a central platform, so that the data consistency and immediacy is automatically ensured, and additional interfaces for data exchange are unnecessary.

An exchange of component parts and/or freestanding devices can be performed in the schemas in an automated operation by means of intelligent mechanisms.

A further advantage of the exemplary embodiment is that multiple storing of identical documents can be prevented by the automated collection of the device documents.

Furthermore, lists with cost sheets and delivery limits can be generated in an automated operation, so that by entering or assigning costing quantities to the schemas, cost sheets are also possible without generating instances.

The exemplary systems and methods can be used in process planning, system planning or control and instrumentation planning, where assignments of central data to mass data enable specific instances to be generated and then further processed. However, they can also be applied in technical planning, as for example in process engineering, plant engineering, system engineering, automation engineering, electrical engineering and cabling.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. System for automated generation, management and documentation of device assemblies by means of a data processing system, which includes at least one data source for the supply of mass data and an entry module for creating and managing objects, where
the entry module interacts with a graphic module, which generates schemas from a combination of the created objects, and
the schemas generated by the graphic module can be transferred into a processing module for the generation of one-to-one corresponding instances by means of a multiple allocation of the schemas to the mass data.

2. System according to claim 1, wherein the one-to-one corresponding instances generated by the processing module can be represented and/or further processed as device assemblies with a complete documentation by means of an evaluation module.

3. System according to claim 2, wherein parts lists can be generated for the device assemblies in an automated operation through the combination of the created objects.

4. System according to claim 2, wherein the generated device assemblies and parts lists can be graphically represented by means of an output and/or display module, and/or counts, statistics and summaries can be generated from them.

5. System according to claim 1, wherein prices, discounts and/or costs can be allocated to the objects and schemas for generating cost statements, cost catalogues and/or purchase requisitions.

6. System according to claim 1, wherein the objects and schemas can be allocated associated documents, which, taking into account the generated instances of the objects and schemas used, can be saved in a central database.

7. System according to claim 1, wherein the creation and management of the objects and schemas and/or the management of the mass data records can be executed by means of a central platform.

8. System according to claim 1, wherein an exchange of objects can be performed in the schemas in an automated operation by means of intelligent mechanisms.

9. System according to claim 1, wherein, by entering or assigning costing quantities to the schemas, cost sheets can also be generated without generating instances, and/or lists with cost sheets and delivery limits can be generated in an automated operation.

10. System according to claim 3, wherein, on the basis of the parts lists and device assemblies, purchase requisitions can be generated and managed.

11. System according to claim 1, wherein the objects are uniquely named by an identifier, can be described by defined data fields and/or contain freely configurable symbols for representation in the generated schemas.

12. Method for automated generation, management and documentation of device assemblies by means of a data processing system, where
mass data is supplied by means of at least one data source,
objects are created and managed by means of the entry module,
from the objects created by the entry module, schemas are created by a graphic module through a combination of the objects, and
the schemas generated by the graphic module are transferred into a processing module for the generation of one-to-one corresponding instances by means of a multiple allocation of the schemas to the mass data.

13. Method according to claim 12, wherein the one-to-one corresponding instances generated by the processing module are represented and/or further processed as device assemblies with a complete documentation by means of an evaluation module.

14. Method according to claim 13, wherein parts lists are generated for the device assemblies in an automated operation through the combination of the created objects.

15. Method according to claim 14, wherein the generated device assemblies and parts lists are graphically represented by means of an output and/or display module, and/or counts, statistics and summaries are generated from them.

16. Method according to claim 12, wherein prices, discounts and/or costs are allocated to the objects and schemas for generating cost statements, cost catalogues and/or purchase requisitions.

17. Method according to claim 12, wherein the objects and schemas are allocated associated documents, which, taking into account the generated instances of the objects and schemas used, are saved in a central database.

18. Method according to claim 12, wherein the creation and management of the objects and schemas and/or the management of the mass data records is executed by means of a central platform.

19. Method according to claim 12, wherein an exchange of objects is performed in the schemas in an automated operation by means of intelligent mechanisms.

20. Method according to claim 12, wherein, by entering or assigning costing quantities to the schemas, cost sheets are also generated without generating instances, and/or lists with cost sheets and delivery limits are generated in an automated operation.

21. Method according to claim 12, wherein, on the basis of the parts lists and device assemblies, purchase requisitions are generated and managed.

22. Use of the system and method according to claim 12 in technical planning, in particular in process engineering, plant engineering, system engineering, automation engineering, electrical engineering or cabling.

23. System according to claim 4, wherein prices, discounts and/or costs can be allocated to the objects and schemas for generating cost statements, cost catalogues and/or purchase requisitions.

24. System according to claim 5, wherein the objects and schemas can be allocated associated documents, which, taking into account the generated instances of the objects and schemas used, can be saved in a central database.

25. System according to claim 6, wherein the creation and management of the objects and schemas and/or the management of the mass data records can be executed by means of a central platform.

26. System according to claim 7, wherein an exchange of objects can be performed in the schemas in an automated operation by means of intelligent mechanisms.

27. System according to claim 8, wherein, by entering or assigning costing quantities to the schemas, cost sheets can also be generated without generating instances, and/or lists with cost sheets and delivery limits can be generated in an automated operation.

28. System according to claim 9, wherein, on the basis of the parts lists and device assemblies, purchase requisitions can be generated and managed.

29. System according to claim 10, wherein the objects are uniquely named by an identifier, can be described by defined data fields and/or contain freely configurable symbols for representation in the generated schemas.

30. Use of the system according to claim 1 in technical planning, in particular in process engineering, plant engineering, system engineering, automation engineering, electrical engineering or cabling.

31. Method for automated generation, management and documentation of device assemblies by means of a data processing system, comprising:
supplying mass data from at least one data source;
creating and managing objects;
creating schemas through a combination of the objects, and
generating one-to-one corresponding instances based on a multiple allocation of the schemas to the mass data.
